(19) United States
(12) Patent Application Publication
(10) Pub. No.: US 2007/0186114 A1
(43) Pub. Date: Aug. 9, 2007

(54) Electric device

(75) Inventors: Michihiro Fujiyama, Kyoto (JP); Hiroyuki Honda, Osaka (JP); Shuji Kimura, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 11/570,204

(22) PCT Filed: May 31, 2005
(86) PCT No.: PCT/JP05/10306

§ 371 Date: Dec. 7, 2006

(30) Foreign Application Priority Data
Jun. 8, 2004 (JP) 2004-169615

(51) Int. Cl. H04K 1/00

(52) U.S. Cl. 713/184

(57) ABSTRACT

An electric device includes means for performing a current user information setting process for defining current user information as user information on the user assumed to be currently performing operation using a main body operation unit, having a user enter a user name and a password of the user when the user attempts to operate the electric device using the main body operation unit, determining whether or not the inputted password is correct, and setting the user information corresponding to the inputted user name as the current user information only when the inputted password is correct.

### TECHNICAL FIELD

The present invention relates to an electric device controllable remotely via a network such as the Internet and operational by a main body operation unit of the electric device.

### BACKGROUND ART

There is, for example, a recording and reproducing apparatus for monitoring that is remotely controllable via a network such as the Internet and is operational by a main body operation unit provided for the recording and reproducing apparatus.

For a user who uses a personal computer to remotely control the recording and reproducing apparatus, a user name, a password, and an authority level are previously provided. The following four levels are provided as authority levels, for example. Information including a user name, a password, and an authority level provided for each user (user information) is registered to the recording and reproducing apparatus.

Level 1 (top level): recording operation, and reproducing operation

Level 2: reproducing operation, and monitoring operation (viewing inputted images only)

Level 3: monitoring operation (viewing inputted images only)

Level 4 (bottom level): operation not allowed

When a user uses a personal computer to remotely control the recording and reproducing apparatus, the recording and reproducing apparatus allows the user to operate within an authority level of the user after confirming a user name and a password of the user.

Conventionally, a user who operates the main body operation unit provided for the recording and reproducing apparatus uses a single password for keylock release to release the keylock. This password for keylock release is different form a password used for remotely controlling the recording and reproducing apparatus using the personal computer.

In the above-described conventional system, a password to be inputted is different depending on whether a user operates the main body operation unit or the personal computer to remotely control, which is inconvenient. Further, because the keylock is released using the single password for keylock release, when there are a plurality of users who use the main body operation unit, all of the plurality of users are required to remember the password for keylock release, and when one of the users changes the password for keylock release, it is necessary to notify other users who use the main body operation unit of a new password for keylock release after the change.

### DISCLOSURE OF THE INVENTION

An object of the present invention is to provide an electric device with which a password to be entered is the same for both cases in which a user operates a main body operation unit and in which remotely controls the main body operation unit using a personal computer, thereby facilitating an operation.

Further, an object of the present invention is to provide an electric device with which, in a state in which one piece of user information is set as a current user information (the user information of the user that is supposed to operate using the main body operation unit), and when a user with a higher authority level than the authority level in the current user information performs an operation above the authority level of the current user information to the main body operation unit, the user may easily set own user information as the current user information.

Further, an object of the present invention is to provide an electric device with which, when the main body operation unit has not been operated for a certain period of time, user information of a virtual default user with a predetermined authority level is automatically set as the current user information.

Further, an object of the present invention is to provide an electric device with which, when there is a key input by operating a specific key, user information of a virtual default user with a predetermined authority level is automatically set as the current user information.

Further, an object of the present invention is to provide an electric device with which, when the main body operation unit has not been operated for a certain period of time, user information of a virtual default user with a predetermined authority level corresponding to a time slot is automatically set as the current user information.

Further, an object of the present invention is to provide an electric device with which, when there is a key input by operating a specific key, user information of a virtual default user with a predetermined authority level corresponding to a time slot is automatically set as the current user information.

An electric device according to the present invention is controllable remotely via a network and operational by a main body operation unit, and includes: memory means for holding content of information previously set including a user name, a password, and an authority level for each of users including a user capable of remotely controlling the device, a user capable of operating the main body operation unit, and a user capable of both remotely controlling the device and operating the main body operation unit; means for having a user enter a user name and a password of the user when the user attempts to remotely control the electric device via a network, and determining whether or not the inputted password is correct, thereby allowing the user to remotely control the device within an authority level included in user information corresponding to the inputted user name only when the inputted password is correct; means for performing a current user information setting process for having a user enter a user name and a password of the user when the user attempts to operate the electric device using the main body operation unit, determining whether or not the inputted password is correct, and setting user information corresponding to the inputted user name as a current user information only when the inputted password is correct, the current user information being defined as user information of a user who is supposed to be currently operating the electric device using the main body operation unit; and means for allowing the user to operate the electric device using the main body operation unit within the authority level included in the user information set as the current user information.

Preferably, the memory means holds default user information, an authority level thereof being set to a predetermined level, and the electric device includes: means for, when a state in which there has been no key input from the main body operation unit of the electric device is maintained for a certain period of time, setting the default user information as the current user information; determining means for, when there has been a key input from the main body operation unit of the electric device, determining whether or not the key input is within an authority level of the current user information; means for, when the determining means has determined that the key input is within the authority level of the current user information, having a process corresponding to the key input be executed; and means for, when the determining means has determined that the key input is not within the authority level of the current user information, having procedures move to a current user information setting process.

The electric device preferably includes: a specific key for having the default user information be set as the current user information; and means for, when there has been a key input by operating the specific key, setting the default user information as the current user information.

It is preferable that the memory means holds default user information, an authority level thereof being set to a predetermined level, and the electric device includes: a specific key for having the default user information be set as the current user information; means for, when there has been a key input by operating the specific key, setting the default user information as the current user information; determining means for, when there has been a key input from the main body operation unit of the electric device, determining whether or not the key input is within an authority level of the current user information; means for, when the determining means has determined that the key input is within the authority level of the current user information, having a process corresponding to the key input be executed; and means for, when the determining means has determined that the key input is not within the authority level of the current user information, having procedures move to a current user information setting process.

Preferably, the memory means holds pieces of default user information, authority levels thereof being set according to each time slot obtained by dividing a day into a plurality of time slots, and the electric device includes: means for, when a state in which there has been no key input from the main body operation unit of the electric device is maintained for a certain period of time, determining a divided time slot to which a current time belongs out of the plurality of divided time slots, and setting the default user information corresponding to the determined time slot as the current user information; determining means for, when there has been a key input from the main body operation unit of the electric device, determining whether or not the key input is within an authority level of the current user information; means for, when the determining means has determined that the key input is within the authority level of the current user information, having a process corresponding to the key input be executed; and means for, when the determining means has determined that the key input is not within the authority level of the current user information, having procedures move to a current user information setting process.

The electric device preferably includes: a specific key for having the default user information be set as the current user information; and means for, when there has been a key input by operating the specific key, determining a divided time slot to which a current time belongs out of the plurality of divided time slots, and setting the default user information corresponding to the determined time slot as the current user information.

It is preferable that the memory means holds pieces of default user information, authority levels thereof being set according to each time slot obtained by dividing a day into a plurality of time slots, and the electric device includes: a specific key for having the default user information be set as the current user information; means for, when there has been a key input by operating the specific key, determining a divided time slot to which a current time belongs out of the plurality of divided time slots, and setting the default user information corresponding to the determined time slot as the current user information; determining means for, when there has been a key input from the main body operation unit of the electric device, determining whether or not the key input is within an authority level of the current user information; means for, when the determining means has determined that the key input is within the authority level of the current user information, having a process corresponding to the key input be executed; and means for, when the determining means has determined that the key input is not within the authority level of the current user information, having procedures move to a current user information setting process.

### BRIEF DESCRIPTION OF THE DRAWINGS

FIG. 1 is a block diagram illustrating a structure of a network system including a recording and reproducing apparatus for monitoring.

FIG. 2 is a flowchart showing procedures when a key on a main body operation unit 12 is operated.

FIG. 3 is a flowchart showing procedures for setting default user information as current user information when there has been no key input for a certain period of time.

FIG. 4 is a flowchart showing another example of the procedures for setting the default user information as the current user information when there has been no key input for the certain period of time.

### BEST MODE FOR CARRYING OUT THE INVENTION

The following describes, with reference to the drawings, embodiments of the present invention applied to a recording and reproducing apparatus for monitoring.

### 1. Description of First Embodiment

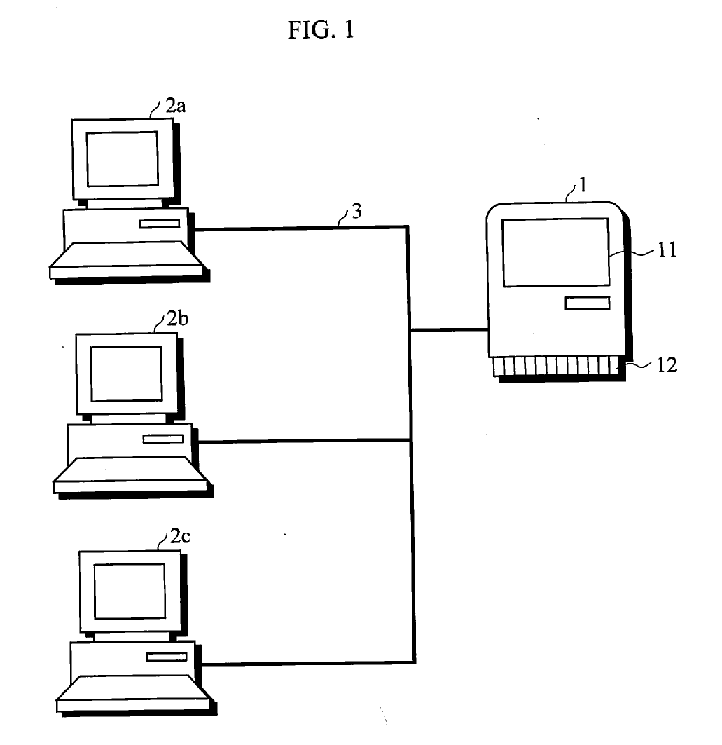

FIG. 1 illustrates a structure of a network system including the recording and reproducing apparatus for monitoring.

This network system includes a recording and reproducing apparatus 1, and a plurality of personal computers 2a, 2b, and 2c (personal computer 2, when referring collectively) connected to the recording and reproducing apparatus 1 via a network 3.

The recording and reproducing apparatus 1 includes a recording and reproducing unit that is not depicted in the drawing, a monitor 11 for displaying an inputted image or a reproduced image, and a main body operation unit 12.

A user may use the main body operation unit 12 to control the recording and reproducing apparatus 1, or may use the personal computers 2a, 2b, and 2c to remotely control the recording and reproducing apparatus 1.

Each of users including a user capable of remote controlling, a user capable of operating the main body operation unit, and a user capable of both remote controlling and operating the main body operation unit, and a main body default user (virtual user) are previously provided with user information containing a user name, a password, and an authority level, as shown in Table 1. The user information for each user is registered to the recording and reproducing apparatus 1.

TABLE 1

| User Name | Password | Authority Level |
|---|---|---|
| TARO | 111 | 1 |
| JIRO | 222 | 2 |
| SABURO | 333 | 3 |
| HANAKO | 444 | 2 |
| YOSHIKO | 555 | 3 |
| YOSHIRO | 666 | 1 |
| HONTAI | 999 | 4 |

Levels 1 to 4 are provided as the authority level. Authorized operations for the levels 1 to 4, respectively, are as follows.

Level 1 (top level): recording operation, and reproducing operation

Level 2: reproducing operation, and monitoring operation (viewing inputted images only)

Level 3: monitoring operation (viewing inputted images only)

Level 4 (bottom level): operation not allowed

In Table 1, items from “TARO” to “YOSHIRO” indicate user names provided for respective users. Among these, “HONTAI” represents a user name provided for a main body default user. The main body default user is a virtual user who operates the main body operation unit 12, whose authority level is set to level 4 (bottom level).

When a user remotely controls the recording and reproducing apparatus 1 using the personal computers 2a to 2c, the recording and reproducing apparatus 1 has the user enter a user name and a password of the user, and determines whether or not the inputted password is correct. Only when the inputted password is correct, the recording and reproducing apparatus 1 sets the personal computers 2a to 2c and the recording and reproducing apparatus 1 in a connected state, in which the remote control is possible, and the recording and reproducing apparatus 1 allows the user to perform the operations within an authority level of the user.

When the user uses the main body operation unit 12 to operate the recording and reproducing apparatus 1, the recording and reproducing apparatus 1 performs a current user information setting process In this process, the recording and reproducing apparatus 1 prompts the user to enter the user name and password, and determines whether or not the inputted password is correct. Only when the inputted password is correct, the recording and reproducing apparatus 1 sets user information corresponding to the inputted user name as current user information.

Note that, the current user information refers to the user information of the user who is supposed to be currently performing the operations using the main body operation unit 12. As described later, when there has been no key input from the main body operation unit 12 for a certain period of time, the current user information is set to the user information (user name: “HONTAI”, password: 999, authority level: 4) of the main body default user. Hereinafter, the user information of the main body default user is referred to as default user information.

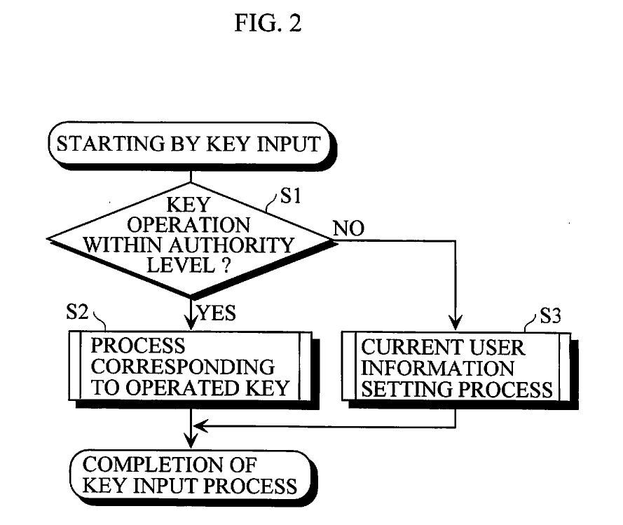

FIG. 2 shows procedures when a key on the main body operation unit 12 is operated.

When the key on the main body operation unit 12 is operated, it is determined whether the key operation is within the authority level of the user information that is currently set as the current user information (Step S1).

If the key operation is within the authority level of the current user information, a process corresponding to the operated key is executed (Step S2). Then, the current procedures are completed.

In the above Step S1, if the key operation is determined to be not within the authority level of the current user information, the current user information setting process (switching process) is executed (Step S3), and then, the current procedures are completed. In Step S1, because a case in which the default user information (user name: “HONTAI”, password: 999, authority level: 4) is set as the current user information always results in NO in Step S1, the procedures moves on to the current user information setting process (Step S3).

In the current user information setting process, an input screen for entering a user name and a password, for example, is displayed, and the user enters the user name and password of the user. The recording and reproducing apparatus 1 determines whether or not the inputted password is correct (whether or not the inputted password matches the password corresponding to the inputted user name). If the inputted password is correct, the recording and reproducing apparatus 1 sets user information corresponding to the inputted user name as the current user information. If the inputted password is not correct, the recording and reproducing apparatus 1 informs the user accordingly and prompts the user to re-enter the password.

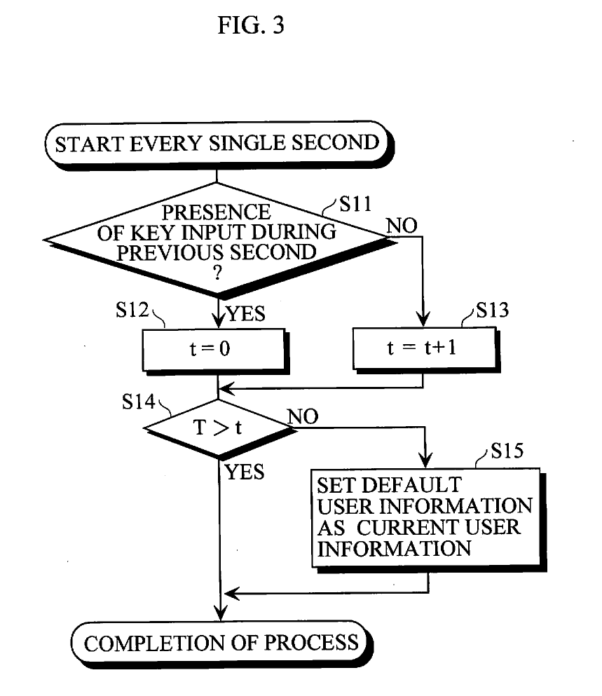

FIG. 3 shows procedures for setting the default user information as the current user information when there has been no key input for the certain period of time.

The procedures is initiated every single second. First, it is determined whether or not there has been a key input during the previous second (Step S11). If there has been a key input during the previous second, a timer t is reset (t=0) (Step S12), and then the procedures move to Step S14.

In the above Step S11, when it is determined there has been no key input during the previous second, the timer t is incremented by 1 (t=t+1) (Step S13), and then the procedures move to Step S14.

In Step S14, it is determined whether or not the timer value t is less than a predetermined time T. If the timer value t is less than the predetermined time T, the current procedures are completed. If the timer value t is not less than the predetermined time T, the current user information is set to the default user information (user name: “HONTAI”, password: 999, authority level: 4) (Step S15), and then the current procedures are completed.

Note that, instead of setting the default user information as the current user information when there has been no key input for a certain period of time, or in addition to setting the default user information as the current user information when there has been no key input for a certain period of time, a specific key may be provided for the main body operation unit 12 in order to set the default user information as the current user information, and the default user information may be set as the current user information when there has been a key input by operating the specific key.

### 2. Description of Second Embodiment

An exemplary case is assumed that an operator who is provided with the authority level 2, for example, is always at the recording and reproducing apparatus 1 during a predetermined time slot. In the first embodiment, the current user information is set to the default user information (user name: “HONTAI1”, password: 999, authority level: 4) if there has been no key input from the main body operation unit 12 for the certain period of time during the time slot in which the operator is at.

In this case, the operator is required to perform current user information setting process every time the operator attempts to operate the main body operation unit 12, which is inconvenient. Therefore, in a second embodiment, during the time slot in which the operator is at, user information of a first main body default user to which the same authority level as the operator's authority level (authority level 2, in this case) is set as the current user information if there has been no key input from the main body operation unit 12 for the certain period of time. On the other hand, if there has been no key input from the main body operation unit 12 for the certain period of time during a time slot other than the time slot in which the operator is at, user information of a usual main body default user to which the authority level 4 is given (second main body default user), as in the first embodiment, is set as the current user information.

More specifically, as shown in Table 2, there are two pieces of default user information registered as the default user information. One piece of the default user information (first default user information) is constituted from data of user name “HONTAI1”, password “901”, and authority level “2”, and the other piece of the default user information (second default user information) is constituted from data of user name “HONTAI2”, password “902”, and authority level “4”.

TABLE 2

| User Name | Password | Authority Level |
|---|---|---|
| HONTAI1 | 901 | 2 |
| HONTAI2 | 902 | 4 |

In this example, it is supposed that an operator who is provided with the authority level 2 (for example, “HANAKO” in Table 1) is at the recording and reproducing apparatus 1 during a time slot from 10:00 to 17:00 every day. Then, a starting time (10:00) and an ending time (17:00) are registered to the recording and reproducing apparatus 1 as an effective time slot for the first default user information (user information with the user name “HONTAI1”).

The procedures when a key on the main body operation unit 12 is operated are the same as in the case of the first embodiment (see FIG. 2).

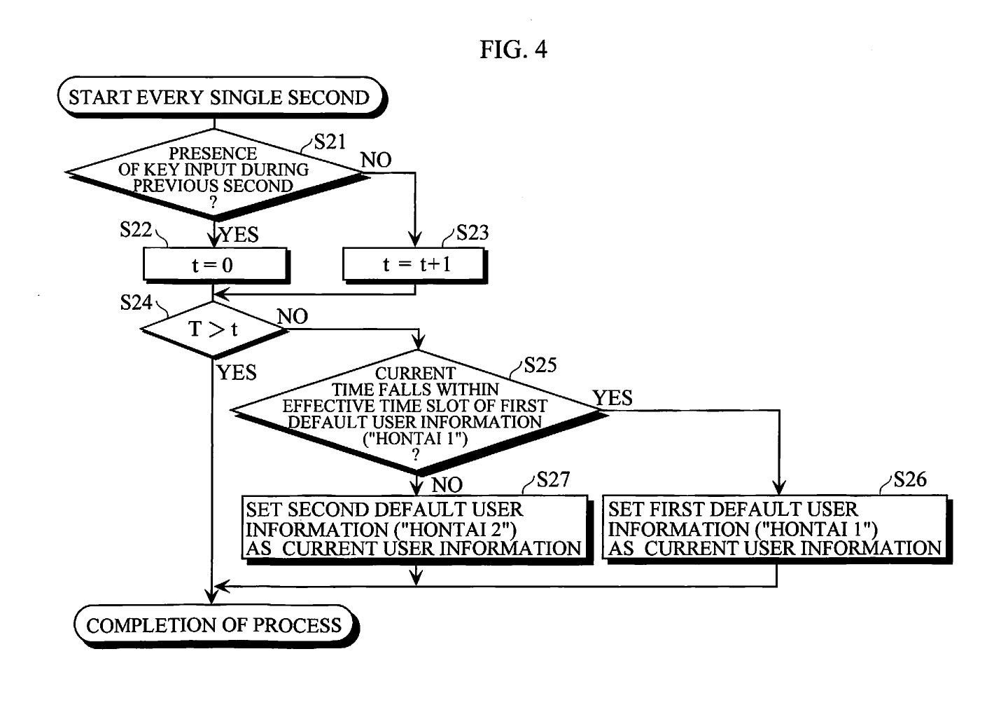

FIG. 4 shows the procedures for setting the default user information as the current user information when there has been no key input for the certain period of time.

The procedures is initiated every single second. First, it is determined whether or not there has been a key input during the previous second (Step S21). If there has been a key input during the previous second, the timer t is reset (t=0) (Step S22), and then the procedures move to Step S24.

In the above Step S21, when it is determined there has been no key input during the previous second, the timer t is incremented by 1 (t=t+1) (Step S23), and then the procedures move to Step S24.

In Step S24, it is determined whether or not the timer value t is less than the predetermined time T. If the timer value t is less than the predetermined time T, the current procedures are completed. If the timer value t is not less than the predetermined time T, it is determined whether or not a current time falls within the effective time slot set for the first default user information (user information with user name “HONTAI1”) (10:00 to 17:00 in this case) (Step S25).

If the current time falls within the effective time slot set for the first default user information (user information with user name “HONTAI1”), the first default user information (user information with user name “HONTAI1”) is set as the current user information (Step S26), and the current procedures are completed. If the current time does not fall within the effective time slot set for the first default user information (user information with user name “HONTAI1”), the second default user information (user information with user name “HONTAI2”) is set as the current user information (Step S27), and the current procedures are completed.

Further, instead of setting the default user information as the current user information when there has been no key input for a certain period of time, or in addition to setting the default user information as the current user information when there has been no key input for a certain period of time, a specific key may be provided for the main body operation unit 12 in order to set the default user information as the current user information, and either the first default user information (user information with user name “HONTAI1”) or the second default user information (user information with user name “HONTAI2”) may be set depending on the current time as the current user information when there has been a key input by operating the specific key.

1. An electric device controllable remotely via a network and operational by a main body operation unit, the device comprising:
memory means for holding content of information previously set including a user name, a password, and an authority level for each of users including a user capable of remotely controlling the device, a user capable of operating the main body operation unit, and a user capable of both remotely controlling the device and operating the main body operation unit;
means for having a user enter a user name and a password of the user when the user attempts to remotely control the electric device via a network, and determining whether or not the inputted password is correct, thereby allowing the user to remotely control the device within an authority level included in user information corresponding to the inputted user name only when the inputted password is correct;
means for performing a current user information setting process for having a user enter a user name and a password of the user when the user attempts to operate the electric device using the main body operation unit, determining whether or not the inputted password is correct, and setting user information corresponding to the inputted user name as a current user information only when the inputted password is correct, the current user information being defined as user information of a user who is supposed to be currently operating the electric device using the main body operation unit; and
means for allowing the user to operate the electric device using the main body operation unit within the authority level included in the user information set as the current user information.

2. The electric device according to claim 1, wherein
the memory means holds default user information, an authority level thereof being set to a predetermined level, and
the electric device comprises:
means for, when a state in which there has been no key input from the main body operation unit of the electric device is maintained for a certain period of time, setting the default user information as the current user information;
determining means for, when there has been a key input from the main body operation unit of the electric device, determining whether or not the key input is within an authority level of the current user information;
means for, when the determining means has determined that the key input is within the authority level of the current user information, having a process corresponding to the key input be executed; and
means for, when the determining means has determined that the key input is not within the authority level of the current user information, having procedures move to a current user information setting process.

3. The electric device according to claim 2, comprising:
a specific key for having the default user information be set as the current user information; and
means for, when there has been a key input by operating the specific key, setting the default user information as the current user information.

4. The electric device according to claim 1, wherein
the memory means holds default user information, an authority level thereof being set to a predetermined level, and
the electric device comprises:
a specific key for having the default user information be set as the current user information;
means for, when there has been a key input by operating the specific key, setting the default user information as the current user information;
determining means for, when there has been a key input from the main body operation unit of the electric device, determining whether or not the key input is within an authority level of the current user information;
means for, when the determining means has determined that the key input is within the authority level of the current user information, having a process corresponding to the key input be executed; and
means for, when the determining means has determined that the key input is not within the authority level of the current user information, having procedures move to a current user information setting process.

5. The electric device according to claim 1, wherein
the memory means holds pieces of default user information, authority levels thereof being set according to each time slot obtained by dividing a day into a plurality of time slots, and
the electric device comprises:
means for, when a state in which there has been no key input from the main body operation unit of the electric device is maintained for a certain period of time, determining a divided time slot to which a current time belongs out of the plurality of divided time slots, and setting the default user information corresponding to the determined time slot as the current user information;
determining means for, when there has been a key input from the main body operation unit of the electric device, determining whether or not the key input is within an authority level of the current user information;
means for, when the determining means has determined that the key input is within the authority level of the current user information, having a process corresponding to the key input be executed; and
means for, when the determining means has determined that the key input is not within the authority level of the current user information, having procedures move to a current user information setting process.

6. The electric device according to claim 5, comprising:
a specific key for having the default user information be set as the current user information; and
means for, when there has been a key input by operating the specific key, determining a divided time slot to which a current time belongs out of the plurality of divided time slots, and setting the default user information corresponding to the determined time slot as the current user information.

7. The electric device according to claim 1, wherein
the memory means holds pieces of default user information, authority levels thereof being set according to each time slot obtained by dividing a day into a plurality of time slots, and
the electric device comprises:
a specific key for having the default user information be set as the current user information;
means for, when there has been a key input by operating the specific key, determining a divided time slot to which a current time belongs out of the plurality of divided time slots, and setting the default user information corresponding to the determined time slot as the current user information;
determining means for, when there has been a key input from the main body operation unit of the electric device, determining whether or not the key input is within an authority level of the current user information;
means for, when the determining means has determined that the key input is within the authority level of the current user information, having a process corresponding to the key input be executed; and
means for, when the determining means has determined that the key input is not within the authority level of the current user information, having procedures move to a current user information setting process.

8. An electric device controllable remotely via a network and operational by a main body operation unit, the device comprising:
a memory for holding content of information previously set including a user name, a password, and an authority level for each of users including a user capable of remotely controlling the device, a user capable of operating the main body operation unit, and a user capable of both remotely controlling the device and operating the main body operation unit;
a determining/allowing portion for determining whether or not an inputted password is correct when a user attempts to remotely control the electric device via a network by causing the user to enter a user name and a password of the user, thereby allowing the user to remotely control the device within an authority level included in user information corresponding to the inputted user name only when the inputted password is correct;
a process performing portion for performing a current user information setting process for having a user enter a user name and a password of the user when the user attempts to operate the electric device using the main body operation unit, determining whether or not the inputted password is correct, and setting user information corresponding to the inputted user name as a current user information only when the inputted password is correct, the current user information being defined as user information of a user who is supposed to be currently operating the electric device using the main body operation unit; and
an allowing portion for allowing the user to operate the electric device using the main body operation unit within the authority level included in the user information set as the current user information.

9. The electric device according to claim 8, wherein
the memory holds default user information, an authority level thereof being set to a predetermined level, and
the electric device comprises:
a user information setting portion for setting the default user information as the current user information when a state in which there has been no key input from the main body operation unit of the electric device is maintained for a certain period of time;
a key input determining portion for determining whether or not a key input is within an authority level of the current user information when there has been the key input from the main body operation unit of the electric device;
a first process controlling portion for having a process corresponding to the key input be executed when the key input determining portion has determined that the key input is within the authority level of the current user information; and
a second process controlling portion for having procedures move to a current user information setting process when the key input determining portion has determined that the key input is not within the authority level of the current user information.

10. The electric device according to claim 9, comprising:
a specific key for having the default user information be set as the current user information; and
a second user information setting portion for setting the default user information as the current user information when there has been a key input by operating the specific key.

11. The electric device according to claim 8, wherein
the memory holds default user information, an authority level thereof being set to a predetermined level, and
the electric device comprises:
a specific key for having the default user information be set as the current user information;
a user information setting portion for setting the default user information as the current user information when there has been a key input by operating the specific key;
a key input determining portion for determining whether or not a key input is within an authority level of the current user information when there has been the key input from the main body operation unit of the electric device;
a first process controlling portion for having a process corresponding to the key input be executed when the key input determining portion has determined that the key input is within the authority level of the current user information; and
a second process controlling portion for having procedures move to a current user information setting process when the key input determining portion has determined that the key input is not within the authority level of the current user information.

12. The electric device according to claim 8, wherein
the memory holds pieces of default user information, authority levels thereof being set according to each time slot obtained by dividing a day into a plurality of time slots, and
the electric device comprises:
a determining/setting portion for determining a divided time slot to which a current time belongs out of the plurality of divided time slots when a state in which there has been no key input from the main body operation unit of the electric device is maintained for a certain period of time, and setting the default user information corresponding to the determined time slot as the current user information;
a key input determining portion for determining whether or not a key input is within an authority level of the current user information when there has been the a key input from the main body operation unit of the electric device;
a first process controlling portion for having a process corresponding to the key input be executed when the key input determining portion has determined that the key input is within the authority level of the current user information; and
a second process controlling portion for having procedures move to a current user information setting process when the key input determining portion has determined that the key input is not within the authority level of the current user information.

13. The electric device according to claim 12, comprising:
a specific key for having the default user information be set as the current user information; and
a user information setting portion for determining a divided time slot to which a current time belongs out of the plurality of divided time slots when there has been a key input by operating the specific key, and setting the default user information corresponding to the determined time slot as the current user information.

14. The electric device according to claim 8, wherein
the memory holds pieces of default user information, authority levels thereof being set according to each time slot obtained by dividing a day into a plurality of time slots, and
the electric device comprises:
a specific key for having the default user information be set as the current user information;
a determining/setting portion for determining a divided time slot to which a current time belongs out of the plurality of divided time slots when there has been a key input by operating the specific key, and setting the default user information corresponding to the determined time slot as the current user information;
a key input determining portion for determining whether or not a key input is within an authority level of the current user information when there has been the key input from the main body operation unit of the electric device;
a first process controlling portion for having a process corresponding to the key input be executed when the key input determining portion has determined that the key input is within the authority level of the current user information; and
a second process controlling portion for having procedures move to a current user information setting process when the key input determining portion has determined that the key input is not within the authority level of the current user information.
